(19) United States
(12) Patent Application Publication
(10) Pub. No.: US 2013/0145582 A1
(43) Pub. Date: Jun. 13, 2013

(54) Rope Locking Device

(71) Applicant: Todd M. Chupp, Jacksonville, FL (US)

(72) Inventor: Todd M. Chupp, Jacksonville, FL (US)

(21) Appl. No.: 13/706,955

(22) Filed: Dec. 6, 2012

Related U.S. Application Data
(60) Provisional application No. 61/568,998, filed on Dec. 9, 2011.

(51) Int. Cl. F16G 11/12

(52) U.S. Cl. CPC F16G 11/12
USPC 24/129 R

(57) ABSTRACT

A rope locking device comprising a body, threading holes, a locking member, and a cleat. The rope is threaded through a first threading hole, and the rope is twisted to form a locking loop. The locking loop engages the locking member, and the free end of the rope is passed through the second threading hole, passed through a support, and attached to the cleat. The rope's attachment to the cleat is accomplished in the same manner as a boating rope is attached to a boat cleat, and there is no need to form any knots in the rope.

### RELATED APPLICATION

This application claims the benefit of U.S. Provisional Patent Application Ser. No. 61/568,998, filed on Dec. 9, 2011, the entire contents of which are incorporated herein by this reference.

### BACKGROUND OF THE INVENTION

The present invention relates generally to the field of rope locking devices, and more specifically to locking devices capable of securing a rope, or other line, without requiring a knot in the rope. Past locking devices have required a knot to be tied in the rope, and such knots can become entangled so severely that the line must be cut to be released. More importantly, when a load is placed on the line, these knots can become entangled or tightened to a degree that they are nearly impossible to untie. Releasing the line in these situations requires cutting the line. Other locking devices rely on abrasive surfaces to create friction between the rope and the device, thus holding the rope in place. However, these abrasive surfaces are often destructive to the rope, and such devices are not suitable for applications where the rope must be repeatedly locked and released. Other locking devices require a complex manner of wrapping or threading the rope to create enough locking force to secure the rope. Such devices are often cumbersome and awkward to use for repeated lock and release applications.

The present invention seeks to overcome these problems by delivering a rope locking device that is capable of securing a rope in a knotless, non-destructive manner without the need for complex wrapping, threading, or knot-tying requirements.

### SUMMARY OF THE INVENTION

The rope locking device generally comprises a body, threading holes disposed within the body, locking holes also disposed within the body, and a cleat attached to the body. The rope is threaded through a first threading hole, and passed along the front side of the body before being threaded through the locking hole. The rope is then threaded through the other locking hole, thus forming a locking loop. The rope is threaded through the other threading hole, passed through a support and doubled back towards the cleat. The free end of the rope is then secured to the cleat in the same manner in which a typical boating rope is secured to a boat cleat. Once the free end of the rope is secured to the cleat, the friction between the locking loop and the locking device locks the rope in place without slippage.

In another embodiment, the body can further comprise a cutout area having a locking member disposed within the cutout. The locking member is any member configured to retain the locking loop formed in the rope. The rope passes through the first threading hole, and the locking loop engages the locking member before the rope passes through the second threading hole. The free end of the rope is then passed through the support before engaging the cleat. The friction between the locking loop and the locking member holds the rope securely in place without slippage.

### BRIEF DESCRIPTION OF THE DRAWINGS

FIG. 1 is an elevation of one embodiment of the rope locking device showing the rope threaded through the device, passed through the support, and connected to the cleat. FIG. 2 is an elevation of one embodiment of the rope locking device.

FIG. 3 is an elevation of one embodiment of the rope locking device.

FIG. 4 is an elevation of one embodiment of the rope locking device.

FIG. 5 is an elevation of one embodiment of the rope locking device.

FIG. 6 an elevation showing a segment of rope threaded through the threading holes of the locking device and forming a locking loop that is engaged with the locking member.

FIG. 7 is an elevation of one embodiment of the rope locking device.

FIG. 8 is an elevation of one embodiment of the rope locking device showing the rope threaded through the device and reconnecting to the cleat.

### DETAILED DESCRIPTION OF THE INVENTION

With reference to the drawings, the invention will now be described with regard for the best mode and the preferred embodiment. In general, the device is a releasable rope locking device capable of releasably locking a rope in a knotless, non-destructive manner. The embodiments disclosed herein are meant for illustration and not limitation of the invention. An ordinary practitioner will understand that it is possible to create many variations of the following embodiments without undue experimentation.

The rope locking device 1 is particularly useful where a rope must be repeatedly locked and unlocked to secure an object. For example, the locking device 1 can be used to secure hammocks, clothes lines, cargo tie-downs, or the like. In use, the rope is threaded through the locking device 99, looped around a distal anchor or support member 50, and then secured to the locking device, as explained in more detail below.

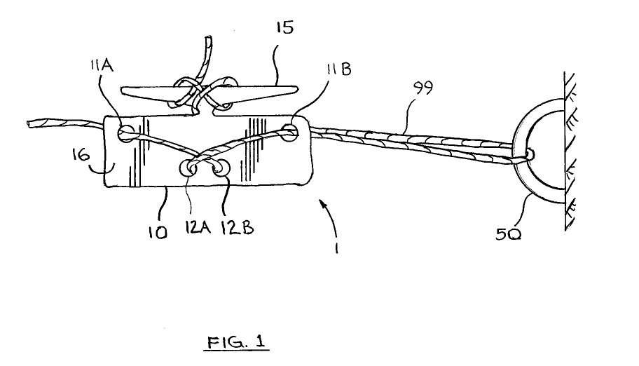

Referring to FIG. 1, the rope locking device 1 generally comprises a body 10, threading holes 11 disposed within the body 10, locking holes 12 also disposed within the body 10, and a cleat 15 attached to the body 10. The body 10 is generally rectangular in shape, and the longitudinal direction of the body 10 is substantially parallel to the direction of the rope 99. The body 10 is made of any metal, plastic, rubber, or other material capable of resisting the load placed on it by the rope 99. In many applications, the body 10 will be made of a plate-like material, such as ⅛-inch thick metal or a variety of other thicknesses. The edges of the body 10 can be filleted, milled, smoothed, or rounded as necessary to remove any sharp edges that may cause damage to the rope 99 as it slides through holes and around edges, as discussed below.

The threading holes 11A and 11B are disposed near the edge of the body 10 and configured to permit the rope 99 to be threaded through the body 10. The separation distance between the threading holes 11A and 11B aids in aligning the longitudinal orientation of the locking device 1 with the direction of the rope 99.

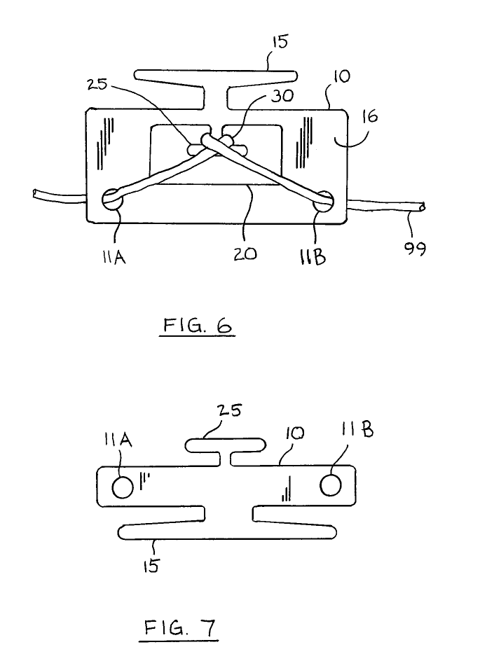

The locking holes 12A and 12B are disposed in the body 10 at a relatively close distance such that when the rope 99 is wrapped through the locking holes 12A and 12B, the close proximity of the holes creates a relatively small radius of curvature in the rope's locking loop 30 (shown in FIG. 6). This small radius of curvature in the locking loop 30 creates a higher level of friction between the rope 99 and the body 10, and this friction prevents slippage between the locking device 1 and the rope 99. The locking holes 12A and 12B can be adapted as needed for specific applications, as shown in FIGS. 1 and 2. For example, as shown in FIG. 1, the threading holes 11A and 11B can be disposed within the body 10 at a location closer to the cleat 15 than that of the locking holes 12A and 12B. Alternately, as shown in FIG. 2, the locking holes 12A and 12B can be disposed within the body 10 at a location closer to the cleat 15 than that of the threading holes 11A and 11B. In most applications, the rope locking device 1 will function properly regardless of which of these embodiment is used.

Referring again to FIG. 1, the rope 99 is threaded through a first threading hole 11A, and passed along the front side 16 of the body before being threaded through the second locking hole 12B. The rope 99 is then wrapped around the back side (not shown) of the body 10 and threaded through the first locking hole 12A, thus forming a locking loop 30 (shown in FIG. 6). The rope 99 again passes along the front side 16 of the body 10 before being threaded through the second threading hole 11B, passed along through the support member 50 and doubled back towards the cleat 15. The free end of the rope 99 is then secured to the cleat 15 in the same crisscross looping manner in which a typical boating rope is secured to a boat cleat. Once the free end of the rope 99 is secured to the cleat 15, the friction between the locking loop 30 and the locking device 1 locks the rope 99 in place without slippage. It is not necessary to tie any knots in the rope 99 to lock it in place, and the rope 99 can be released and re-secured with ease.

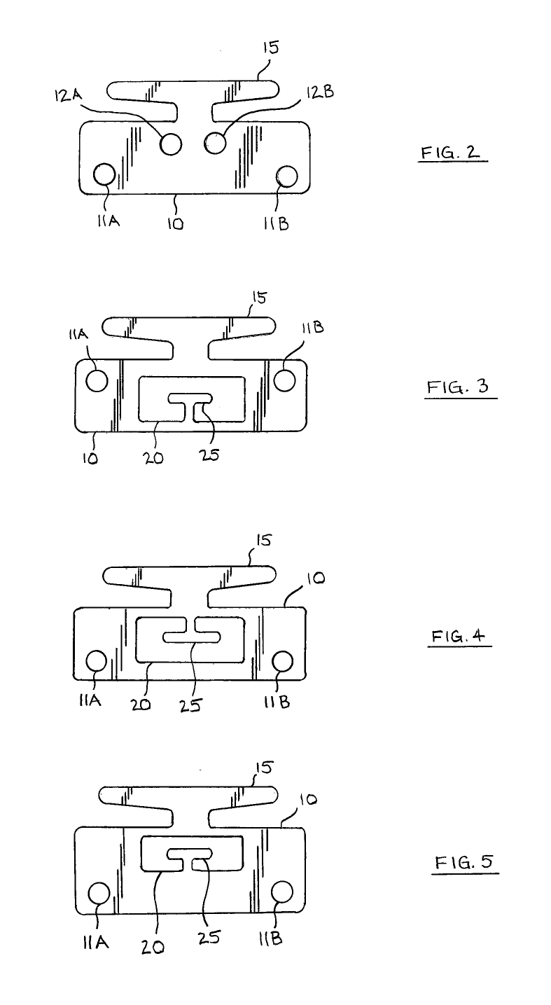

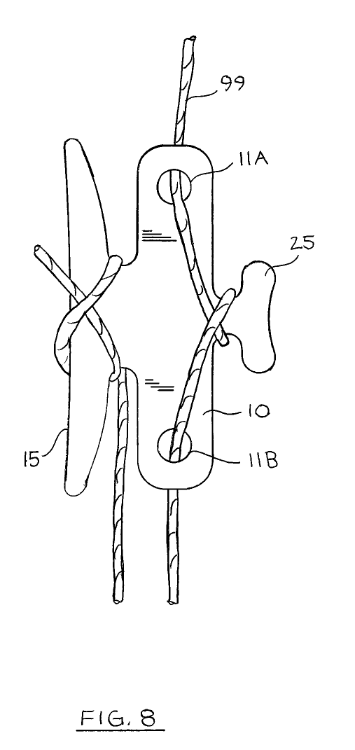

In another embodiment, shown in FIGS. 3-6, the body 10 can further comprise a cutout area 20 having a locking member 25 disposed within the cutout 20. The locking member 25 is any member configured to retain the locking loop 30 formed in the rope 99. The locking member 25 can be a T-stem, hook, clasp, U-ring, D-Ring, O-ring, nailhead-shaped member, or the like. As shown in FIG. 6, the rope 99 passes through the first threading hole 11A, and the locking loop 30 engages the locking member 25 before the rope 99 passes through the second threading hole 11B. The free end of the rope 99 is then passed through the support member 50 before engaging the cleat 15, as discussed above. Again, the friction between the locking loop 30 and the locking member 25 holds the rope securely in place without slippage. In another embodiment, shown in FIGS. 7-8, the cleat 15 and the locking member 25 are disposed external to the body 10. The body 10 comprises the threading holes 11A, 11B, and the locking member 25 is attached to the body 10 on the side opposite that of the cleat 15, as shown in FIGS. 7-8. The locking member 25 is a T-shaped member having a narrow stem configured to create a small radius of curvature in the rope 99, which increases the friction between the rope 99 and the locking member 25. This high level of friction locks the device in place and prevents the device from sliding along the length of the rope 99 under load-bearing conditions.

The foregoing embodiments demonstrate that the locking device 1 provides a non-permanent mounting or securing point along the rope 99. That is, the rope 99 is threaded through the locking device 1 in a manner permitting the position of the device 1 to be adjusted along the length of the rope 99 at any time prior to the free end of the rope 99 being engaged to the locking member 25. Once the point of fixity is selected and the free end of the rope 99 is secured to the locking member 25, the locking device 1 will not slide along the rope 99 when the rope 99 is placed under a load. The rope 99 is easily secured around and released from the locking member 25 when the rope 99 is under a load.

The foregoing embodiments are merely representative of the apparatus and process and not meant for limitation of the invention. For example, one having ordinary skill in the art would understand that there are several embodiments and configurations of locking members that will not substantially alter the nature of the locking device. Consequently, it is understood that equivalents and substitutions for certain elements and components set forth above are part of the invention, and therefore the true scope and definition of the invention is to be as set forth in the following claims.

I claim:

1. A rope locking device comprising:
a body having a plurality of threading holes for receiving a rope member;
a locking member connected to said body, said locking member being a T-stem member; and
a cleat member disposed on one side of the body.

2. The rope locking device of claim 1, wherein said locking member is disposed on the side of the body opposite that of the cleat member.

3. The rope locking device of claim 1, wherein said body further comprises a cutout, said locking member being disposed inside said cutout.

4. A rope locking device comprising:
a body having a plurality of threading holes for receiving a rope member, and a plurality of locking holes for locking said rope member;
a cleat member disposed on one side of the body, said cleat member being a T-stem member.

5. A method of using a rope locking device to lock a rope in a desired position, said rope having a free end, and said method comprising the steps of:
passing the free end of the rope through a first threading hole of said locking device, said locking device having a body, a locking member, and a cleat;
wrapping the rope around the locking member of said locking device;
passing the free end of the rope through a second threading hole disposed in the body of said locking device;
passing the free end of the rope through a distal support member;
returning the free end of the rope to the locking device; and
anchoring the free end of the rope to the locking device by wrapping said rope around the cleat in a crisscross looping manner.
